(19) United States
(12) Patent Application Publication
(10) Pub. No.: US 2021/0319000 A1
(43) Pub. Date: Oct. 14, 2021

(54) DATA DEDUPLICATION AND DATA MERGING

(71) Applicant: JAXSTA ENTERPRISE PTY LTD, Darlinghurst (AU)

(72) Inventor: Philip John Boyd MORGAN, Darlinghurst (AU)

(21) Appl. No.: 17/271,844

(22) PCT Filed: Aug. 27, 2019
(86) PCT No.: PCT/AU2019/050905

§ 371 Date: Feb. 26, 2021

(30) Foreign Application Priority Data
Aug. 31, 2018 (AU) 2018223056

(51) Int. Cl. G06F 16/215; G06F 7/14; G06F 16/25; G06F 16/245

(52) U.S. Cl. CPC G06F 16/215; G06F 16/245; G06F 16/258; G06F 7/14

(57) ABSTRACT

A system (100) for data deduplication and data merging. The system receives attributes associated with data sets from a plurality of sources (102). The system includes a data store (104) that stores: original attributes (106) associated with existing data sets, the attributes including an identifier associated with each data set; merged sets of attributes (108); and an index associating the original attributes and the merged sets of attributes. A processing device (112) is configured to: receive new attributes (114) associated with a data set, wherein the new attributes include a new identifier; and compare the new attributes (114) with the merged sets of attributes to determine a common identifier. Based on the new attributes, the processor updates a set of merged attributes associated with the common identifier, and stores a new index record, or updated index record, that associates the new attributes with the updated set of merged attributes associated with the common identifier.

### TECHNICAL FIELD

The present disclosure relates, generally, to data deduplication and data merging and, more particularly, to a system for and method of deduplicating and merging of metadata associated with data sets.

### BACKGROUND

Metadata is information about data. For example, metadata associated with a media file may include information about the media file's origin, the creator, time and date of creation, etc. For media files in particular, metadata can be useful where the information about its contents may not be directly understandable by a computer, but where efficient search of the content may be desirable. One example is music databases where a user may wish to search for songs, for example based on the artist or album name, in which case the song name, artist name, and/or album name may be included in the associated metadata and used to facilitate search functionality.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In one aspect there is provided a system for data deduplication and data merging wherein the system receives attributes associated with data sets, said attributes received from a plurality of sources, the system including: a data store that stores: original attributes associated with existing data sets, the attributes including an identifier associated with each data set; merged sets of attributes; and an index associating the original attributes and the merged sets of attributes; and a processing device configured to: from a first source, receive new attributes associated with a data set, wherein the new attributes include a new identifier; compare the new attributes with the merged sets of attributes to determine a common identifier; based on the new attributes, update a set of merged attributes associated with the common identifier; and store a new index record, or updated index record, that associates the new attributes with the updated set of merged attributes associated with the common identifier.

The processing device may further be configured to: translate the new attributes to a standardised format.

The data store may include: a first database that includes original attributes received from the first source that are associated with existing data sets; and the processing device may further be configured to: compare the new attributes with the stored original attributes associated with existing data sets received from the first source to determine a matching identifier; determine a first delta as a difference between the new attributes and the original attributes associated with existing data sets received from the first source for the matching identifier; and based on the determined first delta, update stored original attributes in the first database associated with the matching identifier.

The data store may include a main database that includes the merged sets of attributes, wherein said merged sets of attributes are unified from one or more sources; and the processing device may be configured to: compare the updated stored original attributes in the first database with corresponding attributes of data sets from the plurality of sources to determine differences in attributes, said differences corresponding to respective sources; select differences in attributes based on a hierarchy of the corresponding sources; determine a second delta based on the selected differences in attributes; and update a corresponding stored attribute in the main database based on the second delta.

The processing device may further be configured to receive, from a user interface or from a database record, an indication of the hierarchy of the plurality of sources.

In one example of the system, the data store includes a main database that includes the merged sets of attributes, and wherein the processing device is configured to: compare attributes, including the original attributes and the new attributes, associated with the common identifier; select attributes of a select data set that has the least differences in attributes; and update the corresponding set of merged attributes associated with the common identifier based on attributes of the select data set.

If the new identifier does not match any identifier in the merged sets of attributes, the processing device may further be configured to store, in the data store, the new attributes as a new set of attributes.

If a common identifier does not exist, the processing device may further be configured to: compare the new attributes with the merged sets of attributes to identify at least one matching attribute; define a relationship between the new attributes and a set of merged attributes that includes the identified at least one matching attribute; and receive one of: a confirmation that the relationship is valid, whereupon the processing device is configured to update the set of merged attributes based on the new attributes; and a rejection that the relationship is invalid, whereupon the processing device is configure to store, in the data store, the new attributes as a new set of attributes.

The new index record may include a source identifier associated with the new attributes. An updated index record can include an update of an existing record having the common identifier. The update can include additional information including a source identifier associated with the new attributes.

The processing device may further be configured to: receive a query, from a node, in relation to an attribute; and in response to the query retrieve, from the data store, at least one set of merged attributes.

The at least one set of merged attributes may be retrieved from the main database.

The processing device may be configured to compare the new attributes with the merged sets of attributes to determine if the common identifier exists by: comparing primary identifiers of the new attributes and the merged sets of attributes to identify matching primary identifiers; comparing unique identifiers of the new attributes and the merged sets of attributes to identify matching unique identifiers thereby confirming that the matching primary identifiers include the common identifier.

The processing device may be configured to compare the new attributes with the merged sets of attributes to determine if the common identifier exists by: comparing primary identifiers of the new attributes and the merged sets of attributes and determining that a partial match of primary identifiers exists; if the partial match meets a match threshold, comparing unique identifiers of the new attributes and the merged sets of attributes to identify matching unique identifiers thereby classifying the partial match as matching primary identifiers that include the common identifier.

The processing device may be configured to compare the new attributes with the merged sets of attributes to determine if the common identifier exists by: comparing primary identifiers of the new attributes and the merged sets of attributes and determining that no match of primary identifiers exists; comparing unique identifiers of the new attributes and the merged sets of attributes to identify matching unique identifiers; and comparing at least one additional attribute of the new attributes and the merged sets of attributes to determine the common identifier.

The processing device may be configured to compare the new attributes with the merged sets of attributes to determine if the common identifier exists by: comparing primary identifiers of the new attributes and the merged sets of attributes and determining that a partial match of primary identifiers exists; comparing unique identifiers of the new attributes and the merged sets of attributes and determining that no matching unique identifiers exist; comparing at least one additional attribute of the new attributes and the merged sets of attributes and determining that at least a partial match of additional attributes exists; and determining the common identifier based on the partial match of primary identifiers and the partial match of additional attributes.

In one example of the system, the data store comprises, at least in part, cloud storage.

There is also provided a method for data deduplication and data merging, wherein the method is performed by a processing device in communication with a data store, wherein the data store stores: original attributes associated with existing data sets, the attributes including an identifier associated with each data set, wherein the attributes are received from a plurality of data sources; merged set of attributes; and an index associating the original attributes and the merged set of attributes. The method comprises: receiving new attributes associated with a data set, wherein the new attributes include a new identifier; comparing the new attributes with the merged sets of attributes to determine a common identifier; based on the new attributes, updating a set of merged attributes associated with the common identifier; and storing a new index record, or an updated index record, that associates the new attributes with the updated set of merged attributes associated with the common identifier.

In some examples, the method further comprises translating the new attributes to a standardised format.

The data store may include a first database that includes original attributes received from the first source that are associated with existing data sets. The method may further comprise: comparing the new attributes with the stored original attributes associated with existing data sets received from the first source to determine a matching identifier; determining a first delta as a difference between the new attributes and the original attributes associated with existing data sets received from the first source for the matching identifier; and based on the determined first delta, updating stored original attributes in the first database associated with the matching identifier.

In some examples, the data store includes a main database that includes the merged sets of attributes, wherein said merged sets of attributes are unified from one or more source. The method may further comprise: comparing the updated stored original attributes in the first database with corresponding attributes of data sets from the plurality of sources to determine differences in attributes, said differences corresponding to respective sources; selecting differences in attributes based on a hierarchy of the corresponding sources; determining a second delta based on the selected differences in attributes; and updating a corresponding stored attribute in the main database based on the second delta.

The method may further comprise the step of receiving, from a user interface or from a database record, an indication of the hierarchy of the plurality of sources.

In some examples, the data store includes a main database that includes the merged sets of attributes. The method may further comprise: comparing attributes, including the original attributes and the new attributes, associated with the common identifier; selecting attributes of a select data set that has the least differences in attributes; and updating the corresponding set of merged attributes associated with the common identifier based on attributes of the select data set.

In some examples, if the new identifier does not match any identifier in the merged sets of attributes, the method further comprises storing, in the data store, the new attributes as a new set of attributes.

In some examples, if a common identifier does not exist, the method further comprises: comparing the new attributes with the merged sets of attributes to identify at least one matching attribute; defining a relationship between the new attributes and a set of merged attributes that includes the identified at least one matching attribute; and receiving one of: a confirmation that the relationship is valid, whereupon the processing device is configured to update the set of merged attributes based on the new attributes; and a rejection that the relationship is invalid, whereupon the processing device is configure to store, in the data store, the new attributes as a new set of attributes.

In some examples of the method, the new index record, or updated index record, includes a source identifier associated with the new attributes.

In some examples, the method further comprises: receiving a query, from a node, in relation to an attribute; and in response to the query retrieving, from the data store, at least one set of merged attributes.

In some examples, the at least one set of merged attributes is retrieved from the main database.

In some examples, the method further comprises comparing the new attributes with the merged sets of attributes to determine if the common identifier exists by: comparing primary identifiers of the new attributes and the merged sets of attributes to identify matching primary identifiers; and comparing unique identifiers of the new attributes and the merged sets of attributes to identify matching unique identifiers thereby confirming that the matching primary identifiers include the common identifier.

In some examples, the method further comprises comparing the new attributes with the merged sets of attributes to determine if the common identifier exists by: comparing primary identifiers of the new attributes and the merged sets of attributes and determining that a partial match of primary identifiers exists; and if the partial match meets a match threshold, comparing unique identifiers of the new attributes and the merged sets of attributes to identify matching unique identifiers thereby classifying the partial match as matching primary identifiers that include the common identifier.

In some examples, the method further comprises comparing the new attributes with the merged sets of attributes to determine if the common identifier exists by: comparing primary identifiers of the new attributes and the merged sets of attributes and determining that no match of primary identifiers exists; comparing unique identifiers of the new attributes and the merged sets of attributes to identify matching unique identifiers; and comparing at least one additional attribute of the new attributes and the merged sets of attributes to determine the common identifier.

In some examples, the method further comprises comparing the new attributes with the merged sets of attributes to determine if the common identifier exists by: comparing primary identifiers of the new attributes and the merged sets of attributes and determining that a partial match of primary identifiers exists; comparing unique identifiers of the new attributes and the merged sets of attributes and determining that no matching unique identifiers exist; comparing at least one additional attribute of the new attributes and the merged sets of attributes and determining that at least a partial match of additional attributes exists; and determining the common identifier based on the partial match of primary identifiers and the partial match of additional attributes.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1 is a schematic representation of an embodiment of a system for data deduplication and data merging;

FIG. 2 is a flow diagram of an embodiment of a method of data deduplication and data merging;

FIG. 3 is a flow diagram of an embodiment of a method of updating merged attributes;

FIG. 4 is a flow diagram of an embodiment of a method of data deduplication and data merging;

FIG. 5 is a schematic representation of a part of an exemplary embodiment of a method of data deduplication and data merging;

FIG. 6 is a schematic representation of a part of an exemplary embodiment of a method of data deduplication and data merging;

FIG. 7 is a schematic representation of a part of an exemplary embodiment of a method of data deduplication and data merging;

FIG. 8 is a schematic representation of an exemplary embodiment of a primary identifier match comparison algorithm;

FIG. 9 is a schematic representation of an exemplary embodiment of a unique identifier match comparison algorithm;

FIG. 10 is a schematic representation of an exemplary embodiment of a data tree match comparison algorithm;

FIG. 11 is a schematic representation of another exemplary embodiment of a data tree match comparison algorithm;

FIG. 12 illustrates an exemplary embodiment of a portion of an index database; and

FIG. 13 illustrates an example of a processing device.

In the drawings, like reference numerals designate similar parts.

### DESCRIPTION OF EMBODIMENTS

Data sets such as media files and their associated metadata may be provided to users from different distributers. Similarly, the metadata itself may be made available to users from different sources. For example, digital metadata from disparate sources, such as musical supply chain information or manually recorded spreadsheets from record labels, distributors, publishers and other music industry organisations may be provided to users, thereby facilitating ways of searching, accessing, providing, and otherwise using music, video or other media files. The more accurate the metadata is, and the better the metadata can be accessed and searched, the more efficient data sets contained in electronic files (such as media files) can be accessed and used. The more data sets there are that need to be managed and searched properly, for example in large databases or from a large number of sources, the more important it becomes to have an accurate and efficient way of managing and searching the associated attributes contained in the metadata.

When metadata originates from different sources, the attributes described by the metadata may be duplicated or incomplete. The quality of the metadata may therefore be improved by deduplication and merging the metadata received from the different sources. Having a database of deduplicated and merged data improves the efficiency of using and searching data sets with the use of the metadata. Accordingly, described herein is a system that creates a merged metadata database, deduplicates the attributes described by the metadata, and that provides a singular view of the metadata across different data sources and formats. The singular view is a merged and deduplicated version of the combined metadata.

It will be understood that “merging” for the purposes of describing a “merged” database may be implemented in any suitable fashion by the skilled person, as appropriate to the database tools being used. For example, in some embodiments the main database of merged data comprises tags or pointers that reference the original data fields as stored in the database/s that store the original attributes as received from various sources. In these embodiments, the original received data is maintained substantially as received, but referenced via the main database subject to operation rules (for example in order to deduplicate data and/or to prioritise data referenced by the main database based on a hierarchy, as described elsewhere herein).

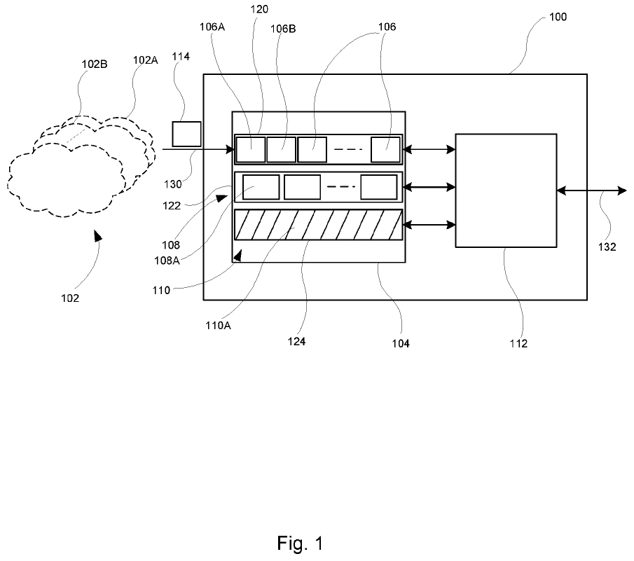

A system 100 for data deduplication and data merging is illustrated in FIG. 1 of the drawings. The system 100 receives attributes associated with data sets from a number of sources 102. The attributes may be in the form of metadata, or may be data related to the metadata of a data set. The data sets may be any type of digital data file, for example a text file or a media file.

The system 100 includes a data store 104 that stores original attributes 106 associated with existing data sets. These attributes include an identifier associated with each data set. The data store 104 stores merged sets of attributes 108, and also an index 110 associating the original attributes 106 and the merged sets of attributes 108. The system 100 also has a processing device 112 configured to receive, from a first source 102A, new attributes 114 associated with a data set. The new attributes 114 include a new identifier. The processing device 112 is configured to compare the new attributes 114 with the merged sets of attributes 108 to determine a common identifier, and based on the new attributes 114, update a set 108A of merged attributes associated with the common identifier. The processing device 112 is configured to store a new index record 110A that associates the new attributes 114 with the updated set 108A of merged attributes associated with the common identifier. This new index record 110A includes a source identifier associated with the new attributes 114, and is stored in an index database 124.

In another example, the processing device 112 can store an updated index record that includes an update of an existing record in the index 110. The existing record having a common identifier and the update including additional information such as a source identifier associated with the new attributes.

The data store 104 includes a first database 120 that includes original attributes 106 from the various sources, for example the original attributes received from the first source 106A. The data store 104 includes a main database 122 that includes the merged sets of attributes 108. These merged sets of attributes 108 are unified from one or more sources 102 (e.g. 102A, 102B, etc.).

The result of providing a merged database (e.g. in the form of the main database 122) is that to the user, at the front end, the consolidated data from the various sources appears to be combined so that the data from various sources is indistinguishable; however in actual fact, at the back end, the data from the various sources remains distinguishable (e.g. the original attributes 106 stored in the first database 120). In addition, the provenance of the original received data is maintained such that the source of specific attributes are distinguishable.

The system 100 includes one or more communication interfaces 130, 132. The attribute communication interface 130 may be used for communicating with the plurality of sources 102 and receiving attributes. The query communication interface 132 may be used for receiving queries in relation to queried attributes and for providing query responses, for example in the form of one or more sets of merged attributes associated with the queried attributes.

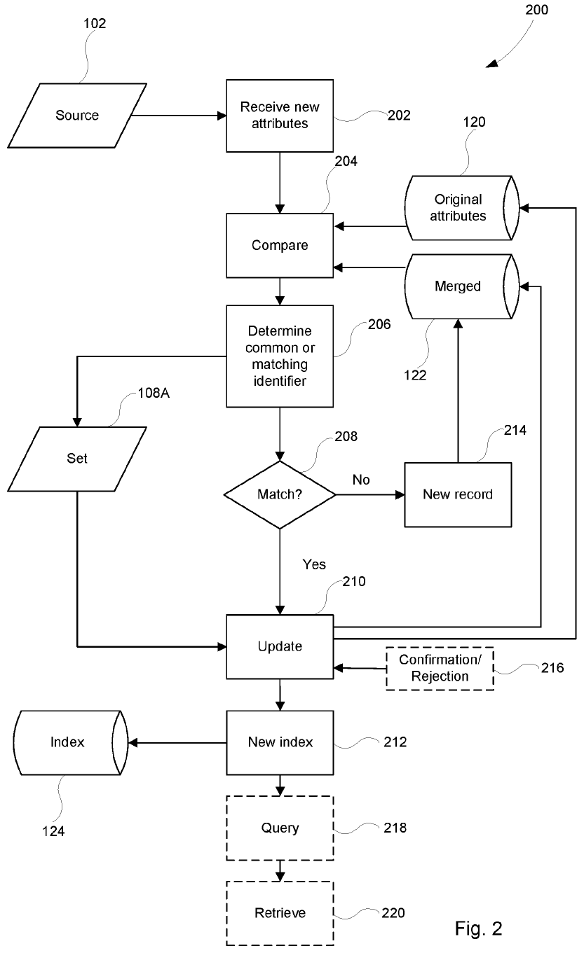

A flow diagram of a method 200 of data deduplication and data merging is illustrated in FIG. 2 of the drawings. The processing device 112 receives 202 new attributes 114 associated with a data set. The new attributes are received from a particular source 102, for example from the first source 102A. The received attributes include an identifier (to avoid ambiguity, referred to here as the “new identifier” being part of the new attributes 114). The processing device 112 compares 204 the new attributes with the merged sets of attributes 108 from the main database 122 to determine 206 whether there is a common identifier, i.e. an identifier that is common to both the new attributes and to attributes already in the main database 122 thereby matching the new and existing attributes. At 208 if it is ascertained that a common identifier exists and there is a match, then the set 108A of merged attributes associated with this common identifier is updated 210 based on the received new attributes. The processing device 112 then also stores a new index record 212, or updated index record, that associates the new attributes with the updated set of merged attributes.

The receiving 202 may include translating the new attributes to a common format, referred to herein as a “standardised format”. Digital metadata for music files, for example, typically have inconsistent data formats and the metadata tends to be transmitted between parties for specific business purposes, e.g. for listing digital music for streaming, or transferring song writing records between publishing companies.

In some embodiments the comparing 204 also includes comparing the new attributes 114 with the stored original attributes 106 associated with existing data sets received from the same source, e.g. the first source 102A. At 206 a matching identifier is then determined, i.e. an identifier of the new attributes 114 matches an identifier in the stored original attributes 106 from the same source. At 208 if it is ascertained that a matching identifier exists, then the original attributes 106 in the first database 120 are updated 210. This updating 210 includes first determining a difference between the new attributes 114 and the original attributes 106 (this difference referred to herein as the “first delta”), and then updating the stored original attributes based on this determined first delta.

In particular, new attributes and original attributes received from the same source are compared. For example, new attributes received from the first source 102A are compared to original attributes also received from the first source 106A. In this step, all the attributes remain separated by source due to the inherent identifier recognition opportunities available within each source. Each source typically has a particular identifier format, consistent across attributes, so that matching identifiers is possible with relative accuracy. Because this is not the case for different sources, having the data compared and updated per source increases the efficiency with which the new attributes 114 are added.

At 208 if it is ascertained that no common identifier exists, i.e. if the new identifier does not match any identifier in the merged sets of attributes 108, then in some embodiments the processing device 112 is configured to store, in the data store 104, the new attributes 114 as a new set of attributes in a new record 214.

In some embodiments, if a common identifier does not exist the processing device 112 may optionally be configured to compare the new attributes 114 with the merged sets of attributes 108 to identify at least one matching attribute and to define a relationship between the new attributes 114 and the particular set of merged attributes that includes this identified matching attribute. The processing device 112 then either receives confirmation 216 that the defined relationship is valid, or a rejection 216 that the relationship is invalid. If the defined relationship is confirmed as valid, then the processing device updates the respective set of merged attributes based on the new attributes 114. Alternatively, if the defined relationship is rejected as invalid, then the processing device stores the new attributes as a new set of attributes in the data store 104.

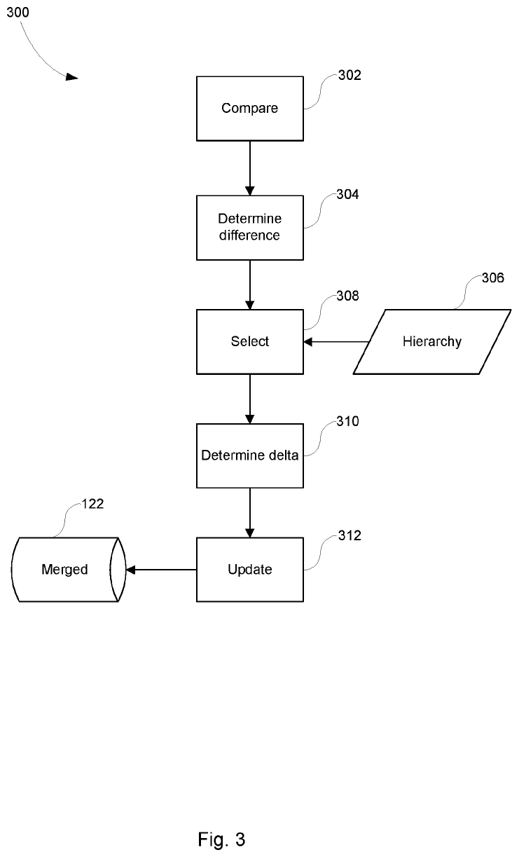

In some embodiments, after receiving and storing new attributes from a particular source, updating 210 the merged attributes may include assessing which of the original received attributes to use for the merged attributes. This assessment may be included if there are any inconsistencies between attributes received from different sources and may be done as illustrated in FIG. 3 of the drawings.

To perform the assessment 300, the processing device 112 compares 302 the updated stored original attributes in the first database 120 with corresponding attributes of data sets from the various sources in order to determine 304 whether the attributes provided from the different sources are the same, or if there are any inconsistencies. If there are differences, a decision must be made as to which received attribute to use to update the merged attributes in the main database 122. This decision is made based on a hierarchy 306 of sources, this hierarchy defining the priority assigned to the various sources in assessing which source to rely on when updating the main database. The processing device 112 selects 308 differences in attributes based on the hierarchy 306 of the sources that correspond to the differences in attributes, and then determines 310 a second delta based on the selected differences in attributes. The corresponding stored attribute in the main database 122 is then updated 312 based on this second delta. In some embodiments, an indication of the hierarchy 306 of the sources is received from a user interface. In some embodiments an indication of the hierarchy of the sources is received from a database record.

Referring again to FIG. 2 of the drawings, in some embodiments, the processing device 112 is configured to receive a query 218, from a node, in relation to an attribute. In response to the query, the processing device 112 retrieves 220, from the data store 104, at least one set of merged attributes from the main database 122.

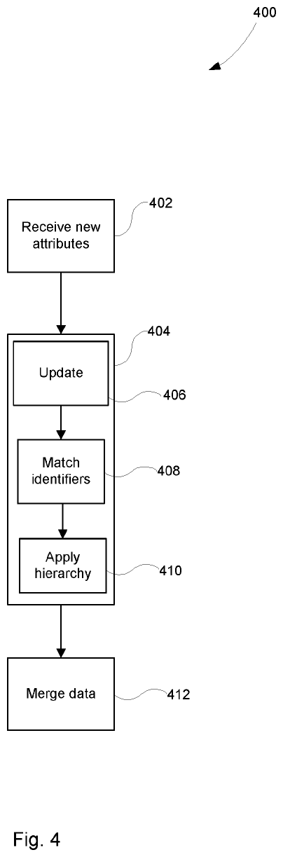

In some embodiments, the method described above with reference to FIG. 2 and FIG. 3 may be implemented in a 3-stage process. The 3-stage process 400 may be understood with reference to FIG. 4 of the drawings.

In Stage One 402 the new attributes 114 received from a particular source (e.g. from the first source 102A) are used to update the original attributes already received from the first source 106A and stored in the first database 120. In Stage One 402 all the attributes remain separated by source due to the inherent identifier recognition opportunities available within each source. Each source typically has a particular identifier format, consistent across attributes, so that matching identifiers is possible with relative accuracy. Because this is not the case for different sources, having the Stage One 402 process assess and update the data per source increases the efficiency with which new attributes are added.

In Stage One 402 the new attributes 114 are received and then converted from the source data format to the standardised format. The new attributes 114 are then compared with the stored original attributes 106 associated with existing data sets received from the various sources 102. Once a matching identifier is determined, i.e. an identifier of the new attributes 114 matches an identifier (or more than one identifier) in the stored original attributes 106, duplicate data is removed from the new attributes 114. “Duplicate data” refers to any part of the new attributes 114 that is already present in the stored original attributes 106. The output of Stage One 402 is a list of data forming part of the new attributes 114 that needs to be added to the stored original attributes. This is the determined difference between the new attributes 114 and the original attributes 106, referred to herein as the “first delta”.

In Stage Two 404 the new attributes 114 are used to update 406 the stored original attributes in the first database 120 based on the first delta as determined in Stage One 402. Matching identifiers are determined 408 that match the new identifier. The matching identifiers form part of the other original attributes received from the various sources 106, and indicate which sets of attributes 106 from the various sources are related, e.g. relating to a common entity identified by the new and matching identifiers. Together, (1) the deduplicated and stored new attributes 114 associated with the new identifier, and (2) the stored original attributes from other sources and associated with the matching identifiers, form a complete set of attributes associated with the particular identifier.

Within this complete set of attributes, the updated stored original attributes 106 in the first database 120 are compared with corresponding attributes of data sets from the various other sources 102 to determine differences in attributes that correspond to respective sources. A hierarchy of sources defining the priority assigned to the various sources in assessing which source to rely on when updating the main database is determined. In some embodiments, an indication of the hierarchy of the sources is received from a user interface. In some embodiments an indication of the hierarchy of the sources is received from a database record. The hierarchy is then applied 410 for selecting differences in attributes, these selected differences in attributes referred to herein as the “second delta”.

In Stage Three 412 corresponding stored attributes in the main database 122 are updated based on the second delta thereby merging 412 the attributes in the main database 122 in order to provide a singular representation of the attributes, i.e. a representation that is unambiguous and that does not include repetition or duplication of data.

Comparison Algorithms

The comparing 204 may be performed utilising one or more comparison algorithms.

Primary identifier matches: In some embodiments, the comparing 204 includes comparing primary identifiers of the new attributes and the merged sets of attributes to identify matching primary identifiers. “Primary identifiers” are the main identifiers or labels used to identify attributes and to determine which attributes are related or belong together. The processing device 112 then also compares unique identifiers of the new attributes and the merged sets of attributes to identify matching unique identifiers. “Unique identifiers” are additional identifiers or labels that can be used to identify attributes and to determine which attributes are related or belong together. The unique identifier match is used to confirm that the matching primary identifiers include the common identifier.

In some embodiments, primary identifiers may include some ambiguity. For example, in alphanumeric primary identifiers, different instances of the same primary identifier may include differences in spelling. In some embodiments, unique identifiers are unambiguous identifiers that are identical across substantially all instances.

Unique identifier matches: In some embodiments, the comparing 204 includes comparing primary identifiers of the new attributes and the merged sets of attributes and determining that a partial match of primary identifiers exists. If the partial match meets a match threshold, then the processing device 112 compares unique identifiers of the new attributes and the merged sets of attributes to identify matching unique identifiers. In this way, the partial match is classified as matching primary identifiers that include the common identifier.

Where primary identifiers include some ambiguity, for example differences in spelling, the partial match may relate to similarities in spelling despite the differences. Where the different but similar primary identifiers are, for example, 60% similar, this may be an indication that the primary identifiers are in fact the same. To determine the likelihood of a match, the similarity is measured against the match threshold. If the match threshold is, for example 55%, then this example of 60% similar would result in the partial match meeting the match threshold. In some examples, this similarity matching can include matching text or text strings (and having matching thresholds). For example, a threshold of 80% match of text, or part of the text, in an artist name and title (in an example where the system is used for data related to music).

In some embodiments, the comparing 204 includes comparing primary identifiers of the new attributes and the merged sets of attributes and determining that no match of primary identifiers exists. In this case, the processing device 112 compares unique identifiers of the new attributes and the merged sets of attributes to identify matching unique identifiers, and then compares at least one additional attribute of the new attributes and the merged sets of attributes in order to determine the common identifier

Data tree matches: In some embodiments, the comparing 204 includes comparing primary identifiers of the new attributes and the merged sets of attributes and determining that a partial match of primary identifiers exists. If a comparison of unique identifiers of the new attributes and the merged sets of attributes results in a determination that no matching unique identifiers exist, then the processing device 112 compares at least one additional attribute of the new attributes and the merged sets of attributes in order to determine that a partial match of additional attributes exists. The processing device 112 then determines the common identifier based on the combination of the partial match of primary identifiers and the partial match of additional attributes.

As described above, where primary identifiers include some ambiguity, for example differences in spelling, the partial match may relate to similarities in spelling despite the differences. Similarly, where additional attributes associated with the respective primary identifiers include both differences and similarities (for example a possible difference in spelling of an alphanumeric attribute), it may be determined that a partial match of the corresponding additional attributes exists.

### Exemplary Embodiment

An exemplary embodiment is a system for the provision of metadata relating to digital music files. The system processes digital metadata from disparate sources, such as musical supply chain information or manually recorded spreadsheets from record labels, distributors, publishers and other music industry organisations into a uniform data format. As a part of this process, the system identifies where entities reside in the data and cross-references matches to provide a deduplicated view of each entity across different data sources and formats. “Entity” in this exemplary embodiment refers to an artist, and the primary identifier in the metadata is the artist's name.

Historically, digital metadata for music recordings and works exists in inconsistent formats, and is typically transmitted between parties only for specific business purposes, i.e. listing digital music for streaming, or transferring song writing records between publishing companies.

Music industry format standards do exist (such as the Digital Data Exchange (DDEX) Electronic Release Notification (ERN) formats), but these are not always used. Consequently, streaming services (for example) have trouble matching entities such as artists correctly, as they are often served with a free text string instead of a linkable identifier. This leads to the problem of identity uncertainty as different data sources may use different text to reference one real-world entity, for example an artist.

Music streaming services typically search and access digital music files based on a name match, then rely on users to deduplicate any incorrect information manually. For example, searching for the artist “Tim Rogers” on a streaming service may show albums for two distinct individuals merged together. The two artists may not have any shared identifiers except for their name. This leads to considerable amounts of information being inaccurately linked. Whilst this gives the illusion of a detailed browsing function to casual users, where there is conflict, it is difficult to untangle from an artist or publisher point of view. Open source databases resort to these methods because they merge multiple accessible sources of information.

There are global identifiers (such as ISNI) that allow entities to be tracked across metadata, however implementation of these identifiers is still in an early stage, and will not fully cover historical scenarios, or facilitate disambiguating pre-existing data. Nonetheless, these global identifiers, when present, can serve as unique identifiers for matching and identifying metadata.

In this exemplary embodiment, even if two entities share a name, this should not necessarily lead to a match in records unless they share other attributes as well. In this way, the accuracy of the deduplicated and merged metadata is improved.

In this exemplary embodiment, the relevant attributes may include one or more of the following:

An “entity” is a person, group of people or organisation. This may be an artist, a record label or any other contributor to a musical catalogue item.

Some “global identifiers” are unique identifiers, for example barcodes, International Standard Musical Work Code (ISWC), International Standard Recording Code (ISRC) and Interested Parties Information Code (IPI) identifiers.

A “release group” is the summary terms of all of the release variants. An album, single, compilation, extended play record (EP) or any other similar music grouping can be a release group.

A “release variant” is a particular grouping of one or many recordings. It is the introduction of a particular group of recordings of work(s) to a market. Different versions of the same album for different territories may be identified as different releases by their identifiers, such as Global Release Identifier (Grid), Universal Product Code (UPC) or International Article Number (EAN). Barcodes are typically used to encode the UPC or EAN.

A “recording” is the final mastered recording of a song, optimally identified by an ISRC. Different mixes of the same song can be assigned different ISRC codes depending on the release process.

A “work” is the compositional element of a song, optimally identified by an ISWC. This means the song ‘as written’, therefore a complete reinvention, remix and retitle of the same song should have the same ISWC as the original version.

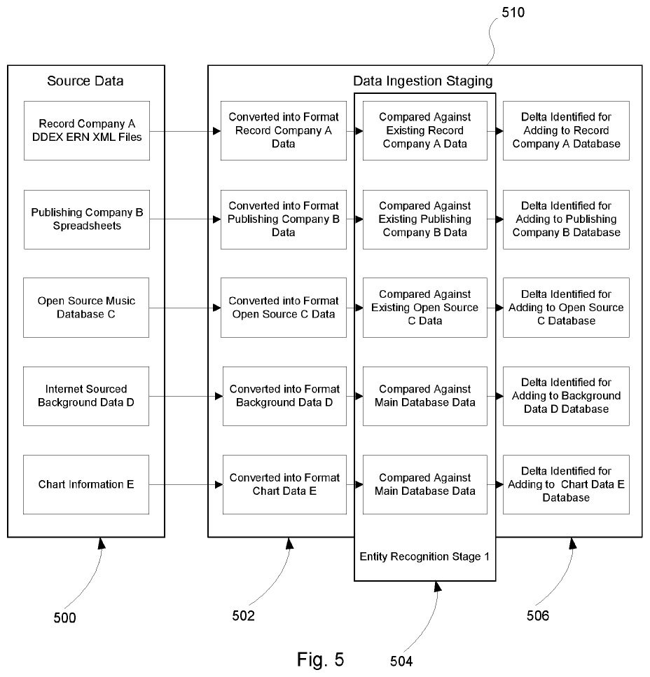

Referring to FIGS. 5 to 7 of the drawings, the 3-stage process for deduplicating and merging metadata relating to digital music files may be performed as follows.

Referring to FIG. 5, in Stage One the new metadata received from a particular music source is converted to a standardised data format (for example a SQL database format such as PostgreSQL). Source data 500 from five difference sources is received, all containing new attributes from a particular source. These are all converted to a standardised format in a format conversion step 502. In Stage One 402 all the attributes remain separated by source due to the inherent identifier recognition opportunities available within each source. Whereas a name might be used to represent several different entities across the entire database, each source usually has a method of separating these entities, whether it involves an identifier or not.

Stage One entity recognition 504 includes comparing the new received records with the existing records already stored in the system. Delta determination 506 provides a list of data forming part of the new records that needs to be added to the stored existing records, and constitutes the “first delta”. Format conversion 502, entity recognition 504, and delta determination 506 together form the data ingestion stage 510.

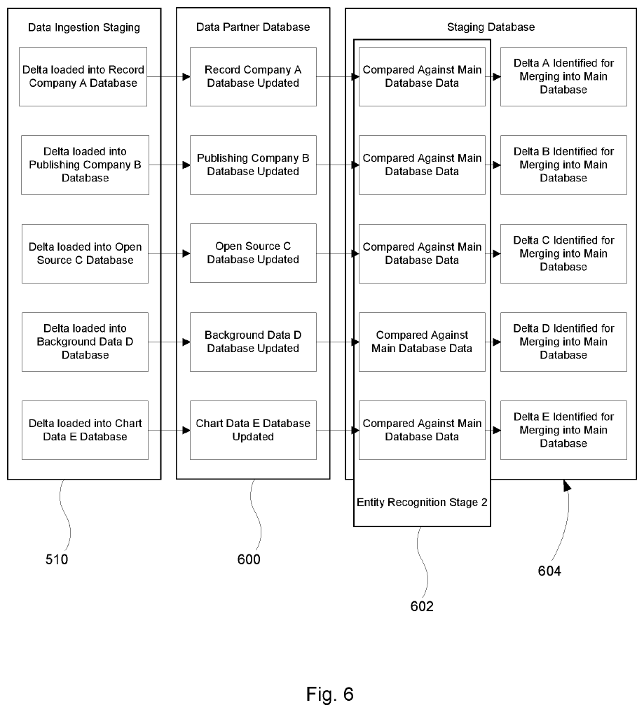

Referring to FIG. 6 of the drawings, following Stage One, the original source databases are updated 600. Following this, in Stage Two the new metadata is used to update the stored metadata. Entity recognition 602 is performed for the main database by first identifying which entities from each data source matches the existing stored metadata, and then seeking to identify a hierarchy of data in order to determine delta data 604 that needs to be added to the main database.

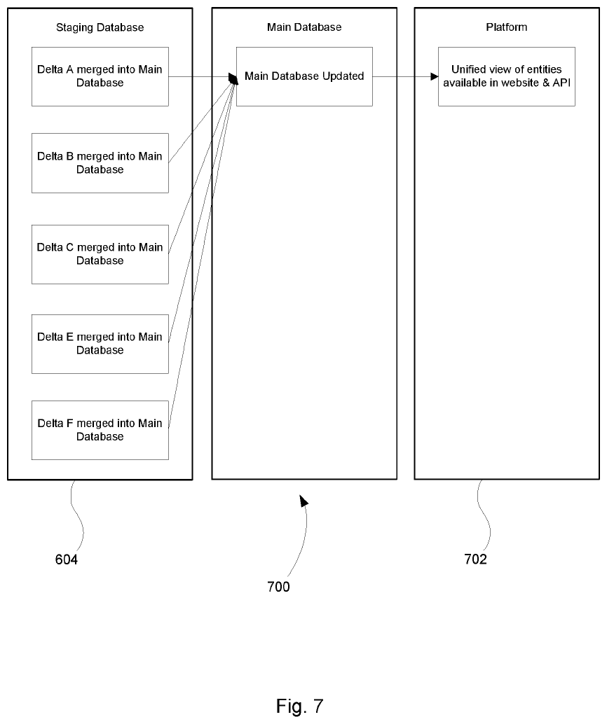

Referring to FIG. 7 of the drawings, in Stage Three all the records that have been identified as delta data 604 that needs to be added to the main database gets merged 700 to provide a deduplicated view 702 of all entities, despite the mix of data from record companies, publishers and other sources for each entity.

The comparison algorithms used in the Stage One entity recognition 504 and/or the Stage Two entity recognition 602 as applied to this exemplary embodiment are as follows:

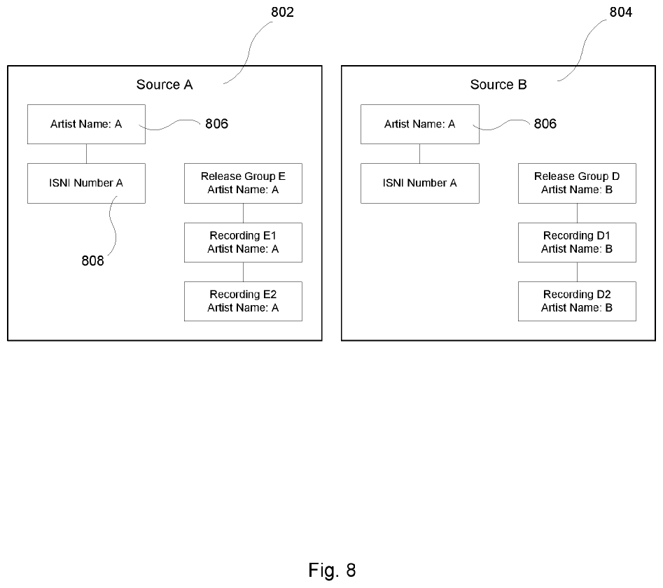

Primary identifier matches: Referring to FIG. 8 of the drawings, data has been received from two sources 802, 804 and the artist name 806 matches across the entities. Although there are no related release group or recording entities, the unique identifier ISNI 808 matches confirming that the same artist names 806 do indeed refer to the same entity.

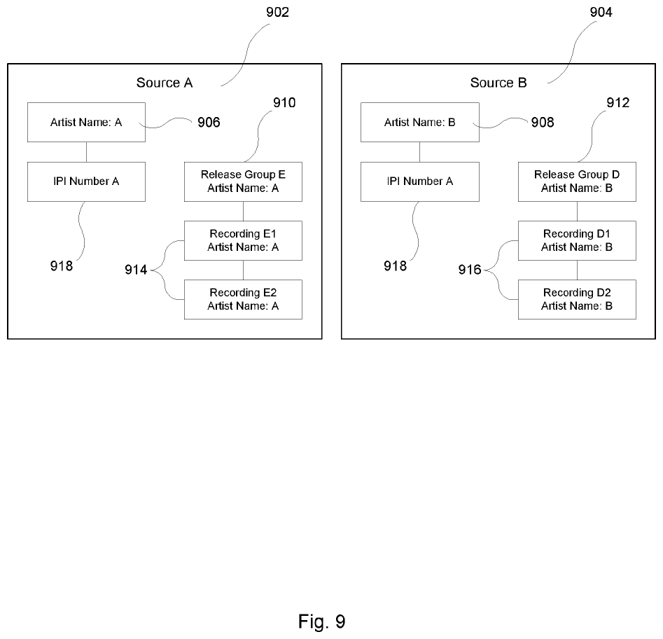

Unique identifier matches: Referring to FIG. 9 of the drawings, data received from two sources 902, 904 includes artist names 906, 908 that do not match, and there are also no related release groups 910, 912 or recording entities 914, 916. There is, however, a matching unique identifier 918, the IPI, so that it can be deduced that the artists are the same entity. In this embodiment, the match is subject to the artist name 906 being at least a partial match measured against a match threshold. In this example, trigrams are used to match the names, and the trigram match is measured against a predefined threshold. For example, where there is an IPI match on the identifier, and the name match between “Beyonce Knowles” and “Beyonce Knowles” satisfies a set trigram threshold, an automatic match is made.

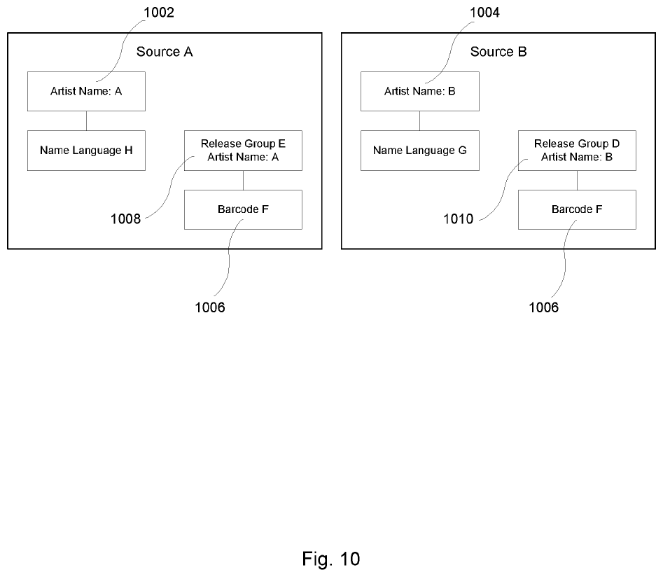

Data tree matches: Referring to FIG. 10 of the drawings, where the artist names 1002, 1004 are different but they are indicated as being presented in two different languages, then the barcode 1006 match implies a high likelihood that the artist is the same entity if they are the only artist listed on the release group 1008, 1010 in both cases.

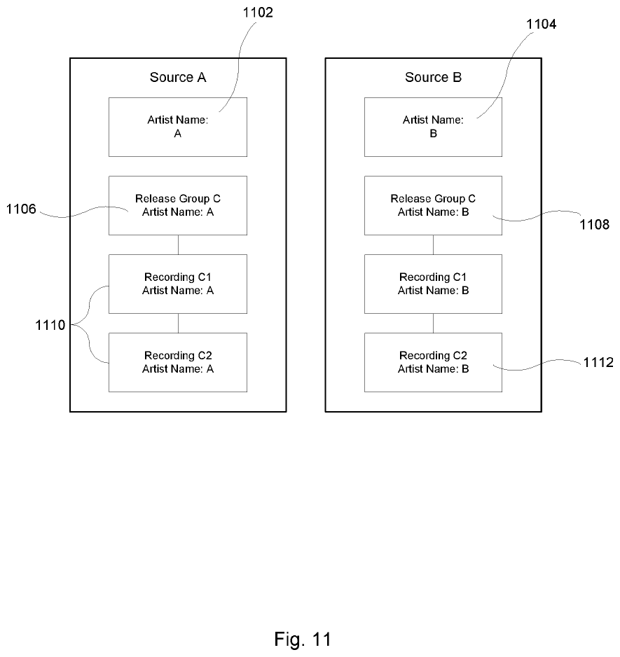

Referring to FIG. 11 of the drawings, where there are two different artist names 1102, 1104 but with a high probability of a trigram name match (i.e. above a match threshold set at, e.g. 95%), the name match is confirmed by the matching release groups 1106, 1008 and the matching recording names 1110, 1112 across the catalogue.

In summary, the system functions based on cascading rules for identifying potential matches in data, namely:
1. Identifying a definitive “perfect identifier” entity resolution based on existing industry standard identifiers such as ISNI, IPI, ISRC, UPC, EAN and ISWC (and any further key identifiers deemed suitable for the purpose) which may be considered to be “unique identifiers. This allows automated matching of records where a clear link exists;
2. Identifying “related perfect identifier” entity matches, where a definitive match can be made from elements without shared identifiers, but where the data has been presented in the context of a data relationship with a related unique identifier. This allows for an inferred match based on applied rules configured with respect to the data tree or data relationship;
3. Identifying entity matches based on configured rules which are determined to allow a perfect entity match without the presence of primary identifiers, based on a recommended match score that satisfies exceeding a configured minimum absolute probability threshold, i.e. the predefined match threshold; and
4. Identifying recommended matches below the minimum absolute probability threshold that may be passed on to a user interface and/or database table for confirmation/rejection as described with reference to FIG. 2.

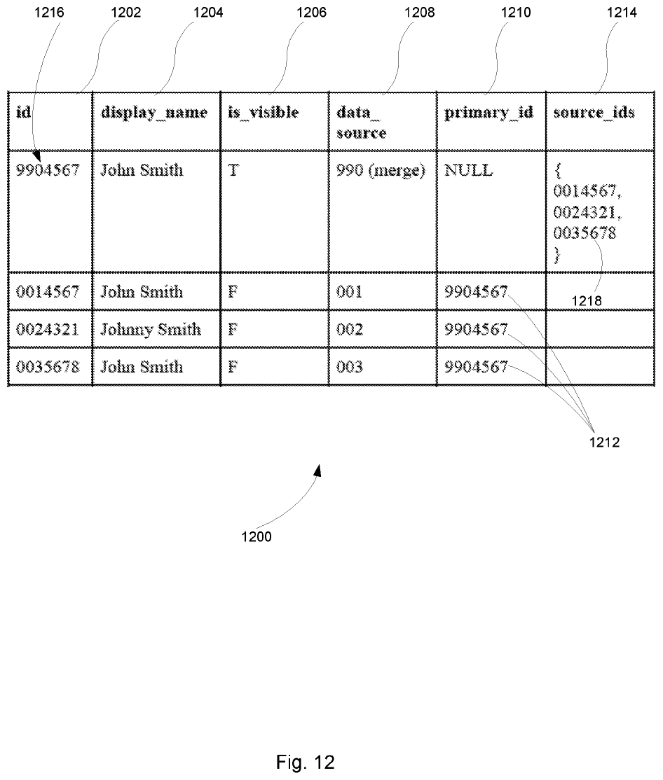

The index for the exemplary embodiment may be understood with reference to the portion of an index database 1200 illustrated in FIG. 12 of the drawings. The first column “id” 1202 is the index record identification. The second column “display_name” 1204 is the entity or artist name. The third column “is_visible” 1206 indicates whether the metadata record is hidden “F” (i.e. the original stored attributes) or visible “T” (i.e. the merged data). The fourth column “data_source” 1208 indicates whether the record is in the merged database or from which data source the record was received. The fifth column “primary_id” 1210 identifies the original record reference 1212. The sixth column “source_ids” 1214 links the merged record 1216 with the originating records 1218 so as to maintain provenance of the data in the merged database.

The index therefore indicates whether the record came from an individual data set or is a merged record from a combination of datasets. In this way all records can be correctly attributed to their source(s) to ensure any usage of the final database can be credited to the initial supplying data partners to enable the development of monitoring and payment systems based on commercialisation of any subsequent data feed. Also, records can be removed from all databases based on the initial data partner source, and any subsequent merged data can be amended to ensure that a record remains where a source has indicated their data should be removed, but another contributing source remains within the data structure

In this exemplary embodiment, maintaining data provenance is useful not only from a data supply chain and accounting perspective, but also in order to ensure rollback. Rollback may be required for example in the case of any errors that may occur in the deduplication and/or merging process. Rollback may also be required if a first data source has supplied data that has been merged with a second data source's data to supplement the data, and later the first data source relinquishes data and the database needs to revert to only the second data source's data.

Variations

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

Selection of Attributes for the Merged Attributes

In one of the above mentioned examples, the attributes of the main database are updated with a second delta which, in turn, is based on a hierarchy of sources. In some further examples, the merged attributes stored in the main database is based on selecting attributes from a data set that is the “best fit” or has “least errors”. This includes having a data store 104 that includes a main database 122 including the merged sets of attributes. After receiving the new attributes, the processing device can compare attributes, including the original attributes and new attributes, that are associated with the same common identifier. In some examples, this can include selecting the attributes from a select data set that has the least differences compared to attributes from attributes of other data sets (that are associated with that common identifier). The corresponding set of merged attributes associated with the common identifier can by updated with that select data set. In one example, this includes showing the attributes of the select data set as the merged set of attributes that are displayed at the front end.

Data Store, Processing Device and Distributed Systems

FIG. 1 illustrates the system 100 with a data store 104 schematically located with the processing device 112. In some examples this includes location at a central server that performs the data deduplication, data merging and response to queries.

In alternative examples, the steps performed by the processing device 112 can be performed by multiple processors. For example, one or more processors are tasked with data deduplication and data merging whilst other processors are tasked with processing queries and retrieving. In yet other examples, the tasks of a processor can be performed by a decentralised and distributed system. In yet further examples, the data store can be part of a distributed storage system. This can include a data store utilising a cloud storage service. In yet further examples, the data storage and processing steps (of the processing device 112) a performed via a cloud storage service.

Processing Device 112

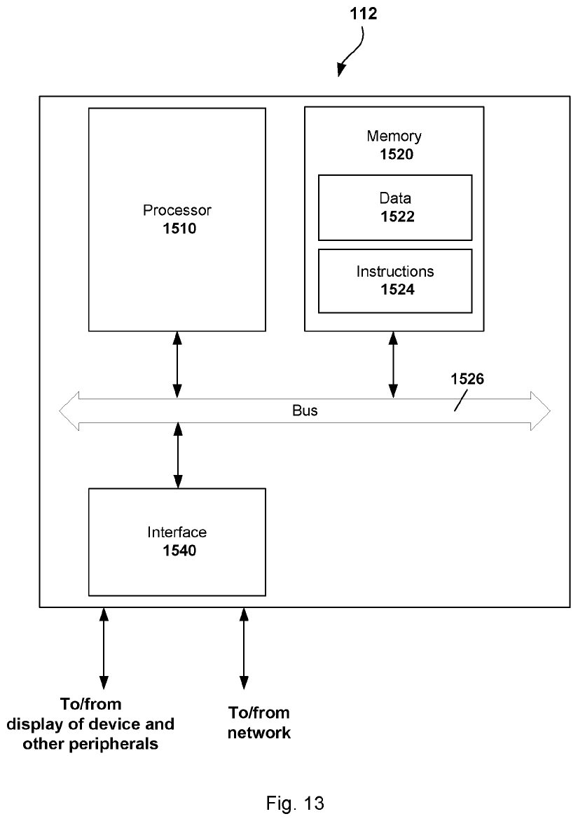

As noted above, the system 100 includes one or more processing device(s) 112. FIG. 13 illustrates an example of a processing device 112. The processing device 112 includes a processor 1510, a memory 1520 and an interface device 1540 that communicate with each other via a bus 1530. It is to be appreciated that the interface 1540 may be one or more interfaces. The memory 1520 may store instructions 1524 and data 1522 for implementing steps in the method 100, 200 described above, and the processor 1510 may perform the instructions from the memory 1520 to implement the steps in the method 200, 300, 400. The interface device 1540 may include a communications module that facilitates communication with the communications network and, in some examples, with peripherals such as a data store 104. It should be noted that although the processing device 112 may be an independent network element, the processing device 112 may also be part of another network element. Further, some functions performed by the processing device may be distributed between multiple network elements. In some examples, the interface 1540 also facilitates communication to other processing devices.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local network or a publically accessible network such as the internet.

It should also be understood that, unless specifically stated otherwise as apparent from the above discussion, it is appreciated that throughout the description, discussions utilizing terms such as “processing” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A system for data deduplication and data merging wherein the system receives attributes associated with data sets, said attributes received from a plurality of sources, the system including:
a data store that stores:
original attributes associated with existing data sets, the attributes including an identifier associated with each data set;
merged sets of attributes; and
an index associating the original attributes and the merged sets of attributes; and
a processing device configured to:
from a first source, receive new attributes associated with a data set, wherein the new attributes include a new identifier;
compare the new attributes with the merged sets of attributes to determine a common identifier;
based on the new attributes, update a set of merged attributes associated with the common identifier; and
store a new index record, or an updated index record, that associates the new attributes with the updated set of merged attributes associated with the common identifier.

2. The system of claim 1, wherein the processing device is further configured to:
translate the new attributes to a standardised format.

3. The system of any one of the preceding claims,
wherein the data store includes:
a first database that includes original attributes received from the first source that are associated with existing data sets; and
wherein the processing device is further configured to:
compare the new attributes with the stored original attributes associated with existing data sets received from the first source to determine a matching identifier;
determine a first delta as a difference between the new attributes and the original attributes associated with existing data sets received from the first source for the matching identifier; and
based on the determined first delta, update stored original attributes in the first database associated with the matching identifier.

4. The system of claim 3:
wherein the data store includes a main database that includes the merged sets of attributes, wherein said merged sets of attributes are unified from one or more sources; and
wherein the processing device is configured to:
compare the updated stored original attributes in the first database with corresponding attributes of data sets from the plurality of sources to determine differences in attributes, said differences corresponding to respective sources;
select differences in attributes based on a hierarchy of the corresponding sources;
determine a second delta based on the selected differences in attributes; and
update a corresponding stored attribute in the main database based on the second delta.

5. The system of claim 4, wherein the processing device is further configured to receive, from a user interface or from a database record, an indication of the hierarchy of the plurality of sources.

6. The system of claim 3:
wherein the data store includes a main database that includes the merged sets of attributes,
wherein the processing device is configured to:
compare attributes, including the original attributes and the new attributes, associated with the common identifier;
select attributes of a select data set that has the least differences in attributes; and
update the corresponding set of merged attributes associated with the common identifier based on attributes of the select data set.

7. The system of any one of the preceding claims, wherein if the new identifier does not match any identifier in the merged sets of attributes, the processing device is further configured to store, in the data store, the new attributes as a new set of attributes.

8. The system of any one of the preceding claims, wherein if a common identifier does not exist, the processing device is further configured to:
compare the new attributes with the merged sets of attributes to identify at least one matching attribute;
define a relationship between the new attributes and a set of merged attributes that includes the identified at least one matching attribute; and
receive one of:
a confirmation that the relationship is valid, whereupon the processing device is configured to update the set of merged attributes based on the new attributes; and
a rejection that the relationship is invalid, whereupon the processing device is configure to store, in the data store, the new attributes as a new set of attributes.

9. The system of any one of the preceding claims, wherein the new index record, or updated index record, includes a source identifier associated with the new attributes.

10. The system of any one of the preceding claims, wherein the processing device is further configured to:
receive a query, from a node, in relation to an attribute; and
in response to the query retrieve, from the data store, at least one set of merged attributes.

11. The system of claim 10, when dependent on claim 4 or 6, wherein the at least one set of merged attributes is retrieved from the main database.

12. The system of any one of claims 1 to 11, wherein the processing device is configured to compare the new attributes with the merged sets of attributes to determine if the common identifier exists by:
comparing primary identifiers of the new attributes and the merged sets of attributes to identify matching primary identifiers; and
comparing unique identifiers of the new attributes and the merged sets of attributes to identify matching unique identifiers thereby confirming that the matching primary identifiers include the common identifier.

13. The system of any one of claims 1 to 11, wherein the processing device is configured to compare the new attributes with the merged sets of attributes to determine if the common identifier exists by:
comparing primary identifiers of the new attributes and the merged sets of attributes and determining that a partial match of primary identifiers exists; and
if the partial match meets a match threshold, comparing unique identifiers of the new attributes and the merged sets of attributes to identify matching unique identifiers thereby classifying the partial match as matching primary identifiers that include the common identifier.

14. The system of any one of claims 1 to 11, wherein the processing device is configured to compare the new attributes with the merged sets of attributes to determine if the common identifier exists by:
comparing primary identifiers of the new attributes and the merged sets of attributes and determining that no match of primary identifiers exists;
comparing unique identifiers of the new attributes and the merged sets of attributes to identify matching unique identifiers; and
comparing at least one additional attribute of the new attributes and the merged sets of attributes to determine the common identifier.

15. The system of any one of claims 1 to 11, wherein the processing device is configured to compare the new attributes with the merged sets of attributes to determine if the common identifier exists by:
comparing primary identifiers of the new attributes and the merged sets of attributes and determining that a partial match of primary identifiers exists;
comparing unique identifiers of the new attributes and the merged sets of attributes and determining that no matching unique identifiers exist;
comparing at least one additional attribute of the new attributes and the merged sets of attributes and determining that at least a partial match of additional attributes exists; and
determining the common identifier based on the partial match of primary identifiers and the partial match of additional attributes.

16. The system of any one of the preceding claims wherein the data store comprises, at least in part, cloud storage.

17. A method for data deduplication and data merging, wherein the method is performed by a processing device in communication with a data store, wherein the data store stores:
original attributes associated with existing data sets, the attributes including an identifier associated with each data set, wherein the attributes are received from a plurality of data sources;
merged set of attributes; and
an index associating the original attributes and the merged set of attributes
wherein the method comprises:
receiving new attributes associated with a data set, wherein the new attributes include a new identifier;
comparing the new attributes with the merged sets of attributes to determine a common identifier;
based on the new attributes, updating a set of merged attributes associated with the common identifier; and
storing a new index record, or an updated index record, that associates the new attributes with the updated set of merged attributes associated with the common identifier.

18. The method of claim 17 further comprising translating the new attributes to a standardised format.

19. The method of either claim 17 or 18, wherein the data store includes a first database that includes original attributes received from the first source that are associated with existing data sets; and wherein the method further comprises:
comparing the new attributes with the stored original attributes associated with existing data sets received from the first source to determine a matching identifier;
determining a first delta as a difference between the new attributes and the original attributes associated with existing data sets received from the first source for the matching identifier; and
based on the determined first delta, updating stored original attributes in the first database associated with the matching identifier.

20. The method of claim 19 wherein the data store includes a main database that includes the merged sets of attributes, wherein said merged sets of attributes are unified from one or more sources; and wherein the method further comprises:
comparing the updated stored original attributes in the first database with corresponding attributes of data sets from the plurality of sources to determine differences in attributes, said differences corresponding to respective sources;
selecting differences in attributes based on a hierarchy of the corresponding sources;
determining a second delta based on the selected differences in attributes; and
updating a corresponding stored attribute in the main database based on the second delta.

21. The method of claim 20, further comprising the step of receiving, from a user interface or from a database record, an indication of the hierarchy of the plurality of sources.

22. The method of claim 19, wherein the data store includes a main database that includes the merged sets of attributes, and wherein the method further comprises:
comparing attributes, including the original attributes and the new attributes, associated with the common identifier;
selecting attributes of a select data set that has the least differences in attributes; and
updating the corresponding set of merged attributes associated with the common identifier based on attributes of the select data set.

23. The method according to any one of claims 17 to 22, wherein if the new identifier does not match any identifier in the merged sets of attributes, the method further comprises storing, in the data store, the new attributes as a new set of attributes.

24. The method according to any one of claims 17 to 23, wherein if a common identifier does not exist, the method further comprises:
comparing the new attributes with the merged sets of attributes to identify at least one matching attribute;
defining a relationship between the new attributes and a set of merged attributes that includes the identified at least one matching attribute; and
receiving one of:
a confirmation that the relationship is valid, whereupon the processing device is configured to update the set of merged attributes based on the new attributes; and
a rejection that the relationship is invalid, whereupon the processing device is configure to store, in the data store, the new attributes as a new set of attributes.

25. The method according to any one of claims 17 to 24 wherein the new index record, or updated index record, includes a source identifier associated with the new attributes.

26. The method of any one of claims 17 to 25, further comprising:
receiving a query, from a node, in relation to an attribute; and
in response to the query retrieving, from the data store, at least one set of merged attributes.

27. The method of claim 26, when dependent on claim 20 or 22, wherein the at least one set of merged attributes is retrieved from the main database.

28. The method of any one of claims 17 to 27, wherein the method further comprises comparing the new attributes with the merged sets of attributes to determine if the common identifier exists by:
comparing primary identifiers of the new attributes and the merged sets of attributes to identify matching primary identifiers; and
comparing unique identifiers of the new attributes and the merged sets of attributes to identify matching unique identifiers thereby confirming that the matching primary identifiers include the common identifier.

29. The method of any one of claims 17 to 27, wherein the method further comprises comparing the new attributes with the merged sets of attributes to determine if the common identifier exists by:
comparing primary identifiers of the new attributes and the merged sets of attributes and determining that a partial match of primary identifiers exists;
if the partial match meets a match threshold, comparing unique identifiers of the new attributes and the merged sets of attributes to identify matching unique identifiers thereby classifying the partial match as matching primary identifiers that include the common identifier.

30. The method of any one of claims 17 to 27, wherein the method further comprises comparing the new attributes with the merged sets of attributes to determine if the common identifier exists by:
comparing primary identifiers of the new attributes and the merged sets of attributes and determining that no match of primary identifiers exists;
comparing unique identifiers of the new attributes and the merged sets of attributes to identify matching unique identifiers; and
comparing at least one additional attribute of the new attributes and the merged sets of attributes to determine the common identifier.

31. The method of any one of claims 17 to 27, wherein the method further comprises comparing the new attributes with the merged sets of attributes to determine if the common identifier exists by:
comparing primary identifiers of the new attributes and the merged sets of attributes and determining that a partial match of primary identifiers exists;
comparing unique identifiers of the new attributes and the merged sets of attributes and determining that no matching unique identifiers exist;
comparing at least one additional attribute of the new attributes and the merged sets of attributes and determining that at least a partial match of additional attributes exists; and
determining the common identifier based on the partial match of primary identifiers and the partial match of additional attributes.
